(19) United States
(12) Patent Application Publication
(10) Pub. No.: US 2006/0168216 A1
(43) Pub. Date: Jul. 27, 2006

(54) Digital management system and method for managing access rights in such a management system

(76) Inventor: Alexander Wolf-Reber, Dietzenbach (DE)

Correspondence Address: KUNZLER & ASSOCIATES, 8 EAST BROADWAY, SUITE 600, SALT LAKE CITY, UT, 84111, US

(21) Appl. No.: 11/008,385

(22) Filed: Dec. 9, 2004

(51) Int. Cl. G06F 15/173

(52) U.S. Cl. 709/225; 709/226

(57) ABSTRACT

An apparatus, system, and method are disclosed for managing access rights in a digital management system. The apparatus includes a device manager module configured to communicate with a client module, and an authorization layer configured to manage client module requests and accounts. The system includes a network, a plurality of client modules, and the apparatus. The method includes communicating with a client module, maintaining a user account data structure and authenticating client modules, managing client module requests and accounts, and maintaining authorization levels for specified devices.

### BACKGROUND OF THE INVENTION

1. Field of the Invention

The invention relates to a digital management system and a method for managing access rights in a network environment where at least two manageable devices are connectable to the network, the management system including a device manager module that handles the communication with at least one client, the device manager module comprising a user account data structure and being responsible for client authentication.

2. Description of the Related Art

Common Information Model (CIM) is an existing standard for system management in a network environment, e.g. Storage Area Network (SAN) in order to manage storage devices connected to the network. The storage area network (SAN) provides a flexible, networked storage infrastructure that decouples storage devices from their respective servers. To accomplish this, the SAN incorporates switch fabric technology, commonly referred to as a SAN fabric, to connect any server to any storage subsystem.

The Common Information Model (CIM) is a computer industry standard for defining device and application characteristics so that system administrators and management programs will be able to control devices and applications from different manufacturers or sources in the same way. For example, a company that purchased different kinds of storage devices from different companies would be able to view the same kind of information (such as: device name and model, serial number, capacity, network location, and relationship to other devices or applications) about each of them or be able to access the information from a program. CIM takes advantage of the Extensible Markup Language (XML). Hardware and software makers choose one of several defined XML schemas (information structures) to supply CIM information about their product.

A CIM Object Manager (CIMOM) handles the communication with the CIM client as well as the encoding/decoding of the CIM XML messages. Moreover it is responsible for client authentication. The CIMOM has a repository where it can store CIM classes and instances persistently. Requests for device objects are delegated to the device providers. These encapsulate the proprietary data models and protocols of the devices as well as the logic of any extrinsic methods. The standard architecture does not provide any fine grade authorization mechanism.

From the foregoing discussion, it should be apparent that a need exists for an apparatus, system, and method that manages access rights in a network environment where at least two manageable devices are connectable to the network. Beneficially such an apparatus, system, and method would include a device manager module that handles the communication with at least one client, comprise a user account data structure, and be responsible for client authentication.

### SUMMARY OF THE INVENTION

The present invention has been developed in response to the present state of the art, and in particular, in response to the problems and needs in the art that have not yet been fully solved by currently available digital management systems. Accordingly, the present invention has been developed to provide an apparatus, system, and method for managing access rights in a network environment that overcome many or all of the above-discussed shortcomings in the art.

The present invention provides a digital management system and a method for managing access rights in a network environment where at least two manageable devices are connectable to the network, the management system including a device manager module that handles the communication with at least one client, the device manager module comprising a user account data structure and being responsible for client authentication.

In one embodiment, the digital management system is characterized by an authorization layer which integrates client request management and account management. The user account data structure of the device manager module is extended, especially a CIM Object Manager, so that authorization levels for specific devices are included in the account data. The device manager module may be configured to check authorization of a user on a system level.

In a further embodiment, the digital management system is characterized in that the device interface is extended in order to allow the device to retrieve a scoping system identifier of any object the device is responsible for. Furthermore, the device manager module is configured to check the authorization of a user on system level.

In another embodiment, an account provider may be coupled to the device manager module, the account provider providing information about access rights and authorization levels of the clients. The device provider may not know anything about user accounts. The account provider may not know anything about systems.

A method of the present invention is also presented for managing access rights in a network environment. The method in the disclosed embodiments substantially includes the steps necessary to carry out the functions presented above with respect to the operation of the described apparatus and system. The method may comprise adding information to the user account data structure for devices that have been granted access by the device manager module. In one embodiment, CIM clients may connect to the CIMOM in order to authenticate with a valid user id and password before they can submit CIM requests. Once authenticated, CIM clients can manage all devices connected to the CIMOM independent of the specific user id. In one embodiment, CIM clients may manage only devices that the device manager module has authorized.

The management method may also comprise checking if the user account has appropriate authorization whenever a client submits a request. In a further embodiment, the management method comprises generating a system scope string for every object managed, and handing the string over to the account provider. The account provider stores authorizations levels in combination with system scope.

A further embodiment of the management method includes retrieving the system scope from the device and the authorization level from the account provider in order to grant or deny the request. Additionally, the management method may include managing accounts as CIM instances which are stored in the CIMOM repository.

The management method may also include interfacing to a directory service such as LDAP. LDAP (Lightweight Directory Access Protocol) is a software protocol that enables any device to locate organizations, individuals, and other resources such as files and devices in a network, whether on the public Internet or on a corporate intranet. In a network, a directory tells you where in the network something is located.

In one embodiment, the management method comprises handling account management by a CIMOM extension which does not offer a provider interface, but some proprietary interface to communicate with the CIMOM and the authorization layer. A further embodiment of the management method includes generating a uniquely identifying string for each device or device provider.

In a further embodiment, the management method includes generating a system scope from a string uniquely identifying a group of objects. Alternatively, the management method may include generating a system scope from a string uniquely identifying an object.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a CIM Proxy module architecture in accordance with the present invention;

FIG. 2 is a schematic block diagram illustrating one embodiment of a CIM Proxy module architecture in accordance with the present invention;

FIG. 3 is a schematic block diagram of the industry standard CIMOM architecture in accordance with the prior art;

FIG. 4 is a schematic flow chart diagram illustrating one embodiment of a method for object enumeration in accordance with the present invention; and

FIG. 5 is a schematic flow chart diagram illustrating one embodiment of a method for object manipulation in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

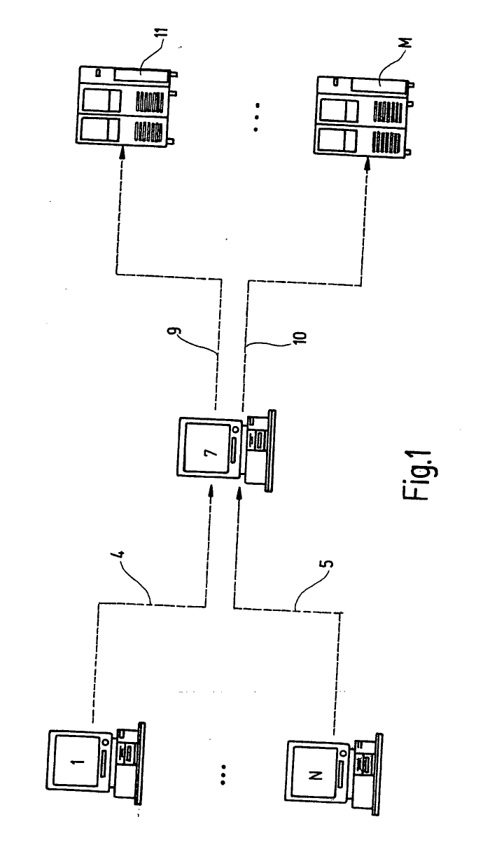

FIG. 1 shows a number of client modules 1 to N connected to a CIM proxy module 7, as indicated by Arrows 4, 5. The connection between client modules 1 to N and CIM proxy module 7 may be realized by the internet for example. The CIM proxy module 7 is connected to devices 11 to M, as indicated by Arrows 9, 10. Client modules 1 to N are hosted by client servers. The CIM proxy module 7 is hosted by a CIM proxy module server. Devices 11 to M are hosted by Device Provider. Client modules 1 to N may be management applications operated by an administrator. The communication between client modules 1 to N and CIM proxy module is realized by CIM/XML-protocol over http. The communication between CIM proxy module and devices 11 to M is realized by a native protocol.

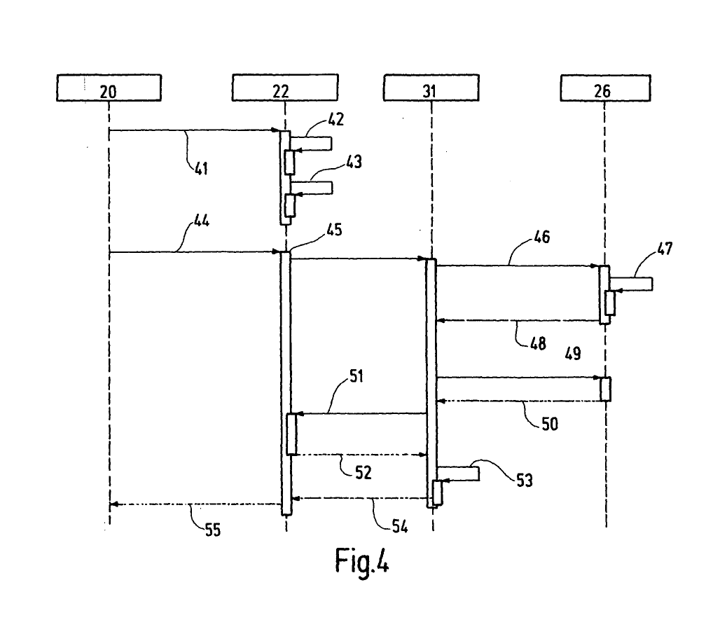

FIG. 3 is a schematic block diagram of the CIM proxy module 7 architecture shown in FIG. 1. A client module 20 communicates with a CIM object manager module 22, as indicated by arrow 21. The CIM object manager module 22 communicates with a repository 24 and with device providers 26 to M. The CIM object manager module 22 is handling the communication with CIM client module 20 as well as the encoding/decoding of the CIM/XML messages. Moreover, the CIM object manager module 22 is responsible for client authentication. CIMOM 22 uses the repository 24 to store CIM classes and instances persistently. Requests for device objects are delegated to the device providers 26 to M.

Devices or device providers 26 to M encapsulate the proprietary data models and protocols of the devices as well as the logic of any extrinsic methods. The standard architecture shown in FIGS. 1 and 3 does not provide any fine grade authorization mechanism. The user context of any request is known by the Device Providers. The device providers may not be responsible for user management.

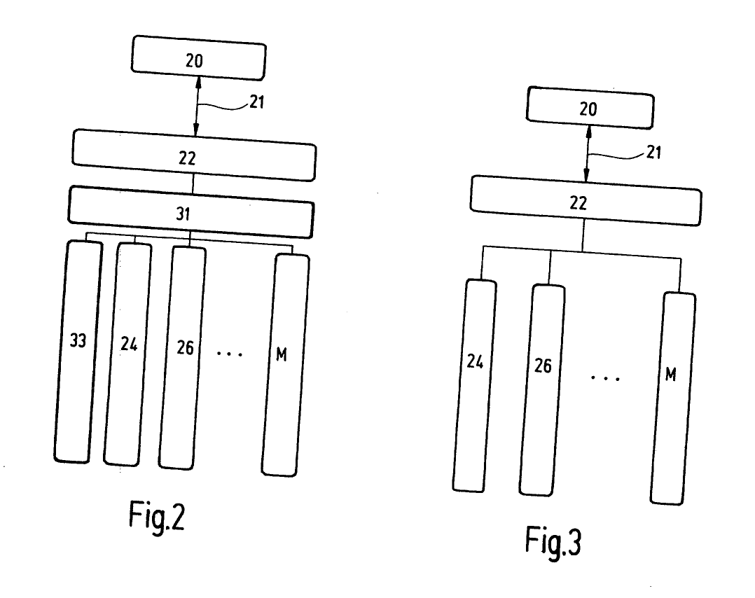

FIG. 2 is a schematic block diagram illustrating one embodiment of the architecture in accordance with the present invention. Compared to the prior art diagram shown in FIG. 3, in FIG. 2 an Authorization Layer 31 is introduced which integrates client request management, account management and device providers 26 to M. An account provider 32 communicates with the authorization layer 31. The authorization layer 31 checks the system scope of any processed object with the device provider 26 to M and evaluates this against the authorization setting from the account provider 33.

In one embodiment, there may be a strict decoupling of responsibilities. The device provider 26 to M does not know anything about user accounts. The account provider 33 does not know anything about systems or devices. The device providers 26 to M generate a system scope string for every object they manage. This string may be handed over to the account provider 33 so it can store authorization levels in combination with system scope. An object access authorization layer 31 retrieves the system scope from the device provider 26 to M and the authorization level from the account provider 33 in order to grant or deny the request.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

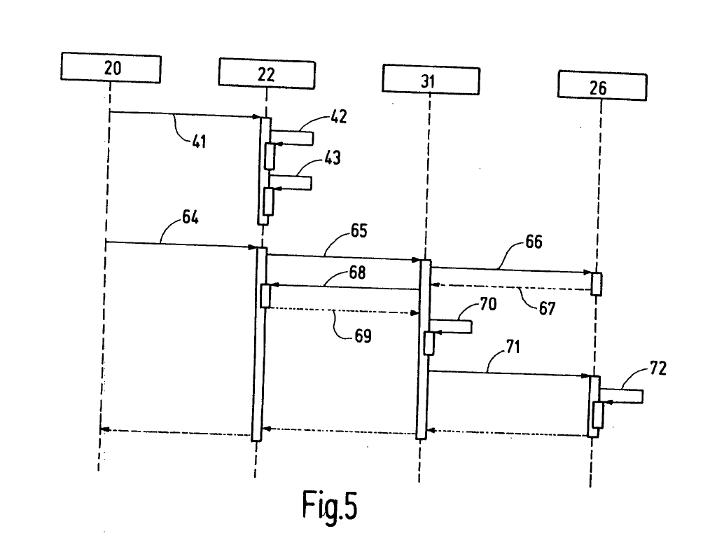

FIG. 4 is a schematic block diagram illustrating a method for object enumeration. The block diagram of FIG. 4 is divided into four columns. The first column is a client module 20. The second column is a CIM object manager module 22. The third column is an authorization layer 31. The fourth column is a device provider 26. In step 41, the client module 20 logs on. In step 42, the CIM object manager module 22 checks authentication of the client module 20. In step 43, the corresponding user roles are provided. In step 44, the client module 20 sends a request to show special objects to the CIM object manager module 20. In step 45, the request is sent from the CIM object manager module 22 to the authorization layer 31. In step 46, the request is transmitted from the authorization layer 31 to the device provider 26.

In step 47, the request is handled in the device providers 26. In step 48, the requested objects are transmitted from the device provider 26 to the authorization layer 31. In step 39, a request to get object system scope is sent from the authorization layer 31 to the device provider 26. In step 50, system scope is transmitted from the device provider 26 to the authorization layer 31. In step 51, a request to get user role for system is sent from the authorization layer 31 to the CIM object manager module 22. In step 52, the user role is transmitted from the CIM object manager module 22 to the authorization layer 31. In step 53, authorization is checked and evaluated. In step 54, the filtered objects are transmitted from the authorization layer 31 to the CIM object manager module 22. In step 55, the filtered objects are transmitted from the CIM object manager module 22 to the client module 20.

FIG. 5 is a schematic flow chart diagram illustrating a method for object manipulation. In step 64, a request to manipulate special object is sent from the client module 20 to the CIM object manager module 22. In step 65, the manipulation request is transmitted from the CIM object manager module 22 to the authorization layer 31. In step 66, a request to get system scope for the special objects is sent from the authorization layer 31 to the device provider 26. In step 67, the system scope is transmitted from the device provider 26 to the authorization layer 31. In step 68, a request to get user role for system is sent from the authorization layer 31 to the CIM object manager module 22. In step 69, the user role is transmitted from the CIM object manager module 22 to the authorization layer 31. In step 70, authorization is evaluated. If the client module 20 is authorized to manipulate the special objects, in step 71, the manipulation request is sent from the authorization layer 31 to the device provider 26. In step 72, the special objects are manipulated in the device provider 26.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for managing access rights in a network environment, the apparatus comprising:
a device manager module configured to communicate with a client module;
wherein the device manager module is configured to maintain a user account data structure and authenticate client modules;
an authorization layer configured to manage client module requests and accounts; and
wherein the user account data structure is configured to maintain authorization levels for specified devices.

2. The apparatus of claim 1, further comprising a plurality of devices, each device configured to manage objects and retrieve a scoping system identifier of the objects.

3. The apparatus of claim 1, further comprising an account provider coupled to the device manager module and configured to provide information about access rights and authorization levels of client modules to the device manager module.

4. The apparatus of claim 1, wherein each device is further configured to generate a system scope string for each controlled object and communicate the system scope string with the account provider.

5. The apparatus of claim 1, wherein the authorization layer is further configured to retrieve the system scope string from the account provider in order to grant or deny an object request.

6. The apparatus of claim 1, wherein the system scope string uniquely identifies the plurality of objects.

7. The apparatus of claim 1, wherein the system scope string uniquely identifies individual objects.

8. The apparatus of claim 1, wherein the device manager module is further configured to check authorization levels in response to a client module request.

9. A system to manage access rights in a network environment, the system comprising:
a network;
a plurality of client modules coupled to the network;
a device manager module configured to communicate with the client modules;
wherein the device manager module is configured to maintain a user account data structure and authenticate client modules;
an authorization layer configured to manage client module requests and accounts; and
wherein the user account data structure is configured to maintain authorization levels for specified devices.

10. The system of claim 9, further comprising a plurality of devices, each device configured to manage objects and retrieve a scoping system identifier of the objects.

11. The system of claim 9, further comprising an account provider coupled to the device manager module and configured to provide information about access rights and authorization levels of client modules to the device manager module.

12. The system of claim 9, wherein each device is further configured to generate a system scope string for each controlled object and communicate the system scope string with the account provider.

13. The system of claim 9, wherein the authorization layer is further configured to retrieve the system scope string from the account provider in order to grant or deny an object request.

14. The system of claim 9, wherein the system scope string uniquely identifies the plurality of objects.

15. The system of claim 9, wherein the system scope string uniquely identifies individual objects.

16. The system of claim 9, wherein the device manager module is further configured to check authorization levels in response to a client module request.

17. A signal bearing medium tangibly embodying a program of machine-readable instructions executable by a digital processing apparatus to perform an operation to manage access rights in a network environment, the operation comprising:
communicating with a client module;
maintaining a user account data structure and authenticating client modules;
managing client module requests and accounts; and
maintaining authorization levels for specified devices.

18. The signal bearing medium of claim 17, wherein the instructions further comprise an operation to manage objects and retrieve a scoping system identifier of the objects.

19. The signal bearing medium of claim 17, wherein the instructions further comprise an operation to provide information about access rights and authorization levels of client modules to a device manager module.

20. The signal bearing medium of claim 17, wherein the instructions further comprise an operation to generate a system scope string for each controlled object and communicate the system scope string with an account provider.

21. A method for managing access rights in a network environment, the method comprising:
communicating with a client module;
maintaining a user account data structure and authenticating client modules;
managing client module requests and accounts; and
maintaining authorization levels for specified devices.

22. The method of claim 21, further comprising managing objects and retrieving a scoping system identifier of the objects.

23. The method of claim 21, further comprising providing information about access rights and authorization levels of client modules to a device manager module.

24. The method of claim 21, further comprising generating a system scope string for each controlled object and communicate the system scope string with an account provider.

25. A method for deploying a computing infrastructure, comprising integrating computer-readable code into a computing system, wherein the code in combination with the computing system is capable managing access rights in a network environment, the method comprising:
communicating with a client module;
maintaining a user account data structure and authenticating client modules;
managing client module requests and accounts; and
maintaining authorization levels for specified devices.

26. The method of claim 25, further comprising managing objects and retrieving a scoping system identifier of the objects.

27. The method of claim 25, further comprising providing information about access rights and authorization levels of client modules to a device manager module.

28. The method of claim 25, further comprising generating a system scope string for each controlled object and communicate the system scope string with an account provider.

29. The method of claim 25, further comprising checking authorization levels in response to a client module request

30. An apparatus to manage access rights in a network environment, the apparatus comprising:
means for communicating with a client module;
means for maintaining a user account data structure and authenticating client modules;
means for managing client module requests and accounts; and
means for maintaining authorization levels for specified devices.
